(19) United States
(12) Patent Application Publication
(10) Pub. No.: US 2020/0361304 A1
(43) Pub. Date: Nov. 19, 2020

(54) MOTOR DEVICE AND MOTOR-DRIVEN TYPE MOVING BODY

(71) Applicant: SONY CORPORATION, TOKYO (JP)

(72) Inventor: TAKASHI TAKAMATSU, TOKYO (JP)

(21) Appl. No.: 16/638,509

(22) PCT Filed: Jul. 31, 2018
(86) PCT No.: PCT/JP2018/028625

§ 371 Date: Feb. 12, 2020

(30) Foreign Application Priority Data
Aug. 21, 2017 (JP) 2017-158639

(51) Int. Cl. B60K 11/02; B60K 7/00; H02K 11/21; H02K 11/25; H02K 9/19

(52) U.S. Cl. CPC B60K 11/02; B60K 7/00; H02K 9/19; H02K 11/25; H02K 11/21

(57) ABSTRACT

There are provided a motor device and a motor-driven type moving body that realize efficient cooling of a motor. The motor device includes a rotary shaft of a hollow structure, a motor section that rotates around the rotary shaft, a coolant circulation pipe that is connected to both ends of the rotary shaft and that constitutes a closed loop shaped coolant circulation path together with a hollow section of the rotary shaft, and a coolant flow control section that controls the flow of a coolant in the coolant circulation pipe. The motor device has a rotational speed sensor that detects the rotational speed of a motor and a temperature sensor that detects the temperature of the motor. The coolant flow control section receives detection information from the rotational speed sensor and the temperature sensor as inputs, and performs a control to accelerate the flow of the coolant in the coolant circulation pipe according to a rise in the rotational speed of the motor and a rise in the temperature of the motor.

### TECHNICAL FIELD

The present disclosure relates to a motor device and a motor-driven type moving body. More specifically, the present disclosure relates to a motor device provided with a cooling mechanism, and a motor-driven type moving body.

### BACKGROUND ART

A motor is rotated by supplying a coil with electric power. Many of the motors generate heat, and have a problem in that the amount of heat generated increases especially at the time of high-speed rotation.

With respect to a configuration for cooling a motor, there have been made various proposals.

For example, PTL 1 (JP 2011-11685A) discloses a configuration in which air is forced to flow from a center shaft of an in-wheel motor to the periphery of a coil, thereby cooling the motor.

In addition, PTL 2 (JP 2015-091198A) discloses a configuration in which a refrigerant is supplied to a rotor axis of a motor to cool a rotor core of the motor.

In the configurations disclosed in these related arts, however, air or the refrigerant as a coolant is supplied from one side of the rotary shaft of the motor and is discharged in the same direction.

Specifically, the coolant is not set to penetrate the rotary shaft of the motor, but the coolant supplied from one side of the rotary shaft of the motor is passed around the inside of the motor and is discharged in the same direction in the returning manner.

With such a configuration, the cooling effect would be lowered, and it may be impossible to restrain sufficiently the heat generation of the motor.

### CITATION LIST

### Patent Literature

[PTL 1]

JP 2011-11685A

[PTL 2]

JP 2015-091198A

### SUMMARY

### Technical Problem

The present disclosure has been made in consideration of the above-mentioned problem, for example. It is an object of the present disclosure to provide a motor device and a motor-driven type moving body that are able to enhance a cooling effect and to restrain effectively the heat generation of a motor.

### Solution to Problem

According to a first aspect of the present disclosure, there is provided a motor device including:

a rotary shaft of a hollow structure;

a motor section rotated around the rotary shaft;

a coolant circulation pipe that is connected to both ends of the rotary shaft and that constitutes a closed loop shaped coolant circulation path together with a hollow section of the rotary shaft; and

a coolant flow control section that controls flow of a coolant in the coolant circulation pipe.

Further, according to a second aspect of the present disclosure, there is provided a motor-driven type moving body including:

a rotary shaft of a hollow structure;

a motor section that rotates around the rotary shaft;

a motor-driven type tire that is equipped with the motor section at a central portion thereof;

a coolant circulation pipe that is connected to both ends of the rotary shaft and that constitutes a closed loop shaped coolant circulation path together with a hollow section of the rotary shaft; and

a coolant flow control section that controls a flow of the coolant in the coolant circulation pipe.

Still further objects, features and advantages of the present disclosure will become apparent from the embodiments of the present invention described later and further detailed descriptions based on the attached drawings. Note that the system herein is a logical set configuration of a plurality of devices, and is not limited to those in which the devices of configurations are present in the same housing.

### Advantageous Effects of Invention

According to the configuration of one embodiment of the present disclosure, a motor device and a motor-driven type moving body that realize efficient cooling of a motor are realized.

Specifically, the motor device includes, for example, a rotary shaft of a hollow structure, a motor section that rotates around the rotary shaft, a coolant circulation pipe that is connected to both ends of the rotary shaft and that constitutes a closed loop shaped coolant circulation path together with a hollow section of the rotary shaft, and a coolant flow control section that controls the flow of the coolant in the coolant circulation pipe. The motor device includes a rotational speed sensor that detects the rotational speed of the motor, and a temperature sensor that detects the temperature of the motor. The coolant flow control section receives detection information from the rotational speed sensor and the temperature sensor as inputs, and performs a control to accelerate the flow of the coolant in the coolant circulation pipe according to a rise in the rotational speed of the motor and a rise in temperature.

By this configuration, a motor device and a motor-driven type moving body that realize efficient cooling of a motor are realized.

Note that the effects described herein are merely illustrative and are not limitative, and additional effects may be present.

### BRIEF DESCRIPTION OF DRAWINGS

FIG. 1 is an explanatory diagram of a configuration example of a motor device of the present disclosure.

FIG. 2 is an explanatory diagram of an internal configuration example of a motor in the motor device of the present disclosure.

FIG. 3 is an explanatory diagram of an example in which the motor device of the present disclosure is mounted to a bicycle which is a moving body.

FIG. 4 is an explanatory diagram of an example in which the motor device of the present disclosure is mounted to a Kickboard which is a moving body.

FIG. 5 is an explanatory diagram of an embodiment in which control of a flow of a coolant in a coolant circulation pipe constituting the motor device of the present disclosure is carried out using detection information from a rotational speed sensor.

FIG. 6 is an explanatory diagram of an embodiment in which control of the flow of the coolant in the coolant circulation pipe constituting the motor device of the present disclosure is carried out using detection information from the rotational speed sensor.

FIG. 7 is an explanatory diagram of an embodiment in which control of the flow of the coolant in the coolant circulation pipe constituting the motor device of the present disclosure is carried out using detection information from a temperature sensor.

FIG. 8 is an explanatory diagram of an embodiment in which control of the flow of the coolant in the coolant circulation pipe constituting the motor device of the present disclosure is carried out using detection information from the temperature sensor.

FIG. 9 is an explanatory diagram of an embodiment in which control of the flow of the coolant in the coolant circulation pipe constituting the motor device of the present disclosure is carried out using detection information from a plurality of temperature sensors.

FIG. 10 is an explanatory diagram of an embodiment in which control of the flow of the coolant in the coolant circulation pipe constituting the motor device of the present disclosure is carried out using detection information from the plurality of temperature sensors.

FIG. 11 is an explanatory diagram of an embodiment in which control of the flow of the coolant in the coolant circulation pipe constituting the motor device of the present disclosure is carried out using detection information from the plurality of temperature sensors.

FIG. 12 is an explanatory diagram of an embodiment in which control of the flow of the coolant in the coolant circulation pipe constituting the motor device of the present disclosure is carried out using a propeller.

FIG. 13 is an explanatory diagram of other embodiments of the motor device of the present disclosure.

### DESCRIPTION OF EMBODIMENTS

A motor device and a motor-driven type moving body according to the present disclosure will be described below, referring to the drawings. The descriptions will be made according to the following items.

1. One configuration example of motor device of the present disclosure

2. A plurality of embodiments of control of flow of coolant in coolant circulation pipe of motor device

3. Other embodiments

4. Summary of configuration of the present disclosure

[1. One configuration example of motor device of the present disclosure]

First, one configuration example of the motor device of the present disclosure will be described.

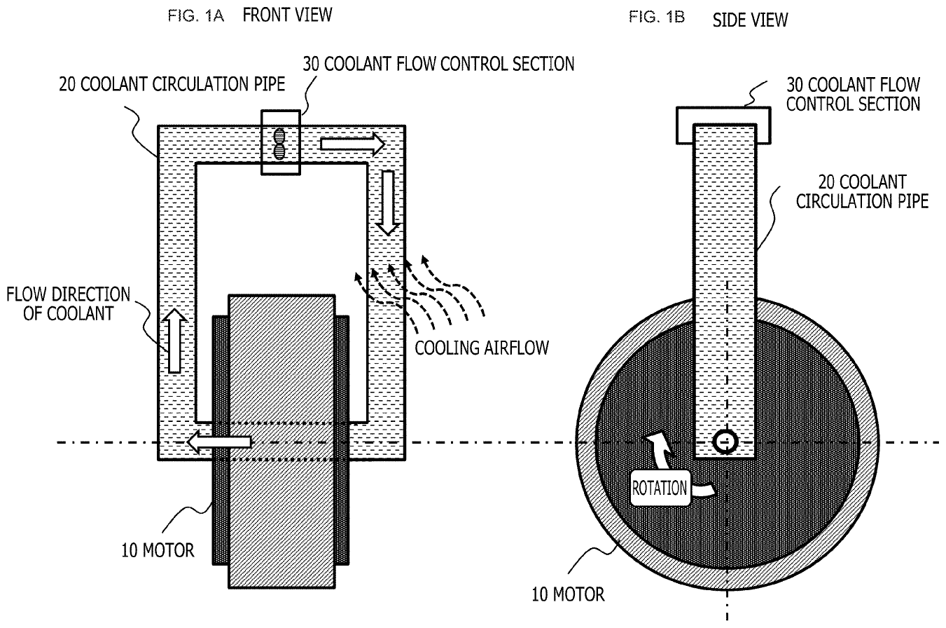

FIG. 1 is an explanatory diagram of one configuration example of the motor device of the present disclosure.

FIG. 1 depicts (a) a front view and (b) a side view of the motor device of the present disclosure.

As illustrated in FIG. 1, the motor device of the present disclosure includes a motor 10, a coolant circulation pipe 20, and a coolant flow control section 30.

The motor 10 is, for example, an in-wheel motor installed at a central portion of a wheel of a moving body such as a bicycle.

It is to be noted, however, that the motor device of the present disclosure is not limited to the in-wheel motor, but is applicable to other motors, for example, various motors such as motors for rotating media such as CD, BD, and hard disk.

As depicted in the side view of FIG. 1 (b), the motor 10 is rotated in a predetermined direction.

The coolant circulation pipe 20 is set to penetrate a center shaft of the motor 10.

The coolant circulation pipe 20 is configured to penetrate a rotary center shaft of the motor 10 and have a closed loop shape surrounding a peripheral portion of the motor 10, and is configured such that a coolant is circulated in the inside of the pipe.

A coolant composed of a liquid or a gas is sealed in the inside of the coolant circulation pipe 20.

The coolant sealed in the inside of the coolant circulation pipe 20 is controlled as to flow velocity or flow direction under control by the coolant flow control section 30.

The coolant flow control section 30 has, for example, a fan or pump configuration, and controls the moving velocity or moving direction of the coolant sealed in the inside of the coolant circulation pipe 20.

The example depicted in the front view of FIG. 1 (a) is a diagram illustrating that the coolant sealed in the inside of the coolant circulation pipe 20 is set to rotate clockwise at a predetermined velocity under control by the coolant flow control section 30.

The flow velocity or flow direction of the coolant can be changed under control by the coolant flow control section 30.

For example, in the case where the rotational speed of the motor 10 increases and the amount of heat generated increases, the coolant flow control section 30 performs a control to accelerate the flow velocity of the coolant.

In addition, for example, based on temperature detection information on the left side and the right side of the motor 10, the coolant flow control section 30 performs a control to change the flow direction of the coolant in such a manner that the coolant will flow from a high temperature side toward a low temperature side.

Specific examples of these flow controls will be described later.

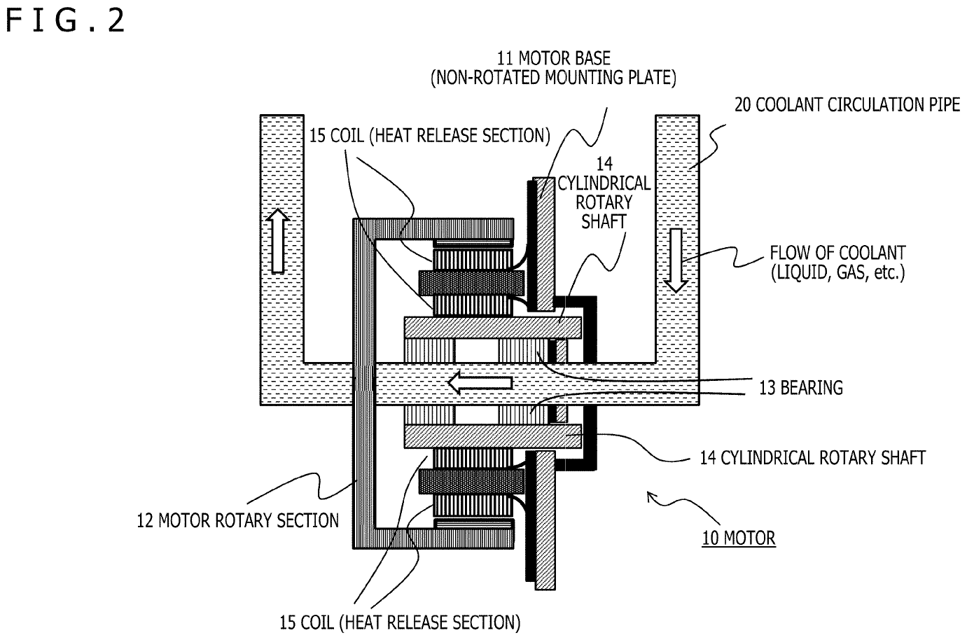

An example of internal structure of the motor 10 will be described below, referring to FIG. 2.

The motor 10 illustrated in FIG. 2 is, for example, an example of structure of an in-wheel motor set in the center of a wheel of a bicycle.

As depicted in FIG. 2, the motor 10 includes a motor base 11 which is a non-rotated mounting plate, and a motor rotary section 12 that is rotated. The motor rotary section 12 rotates as one body with the wheel of the bicycle, for example. Electric power is supplied through the motor base 11 to a coil 15 of the motor rotary section 12, whereby the motor rotary section 12 is rotated.

A cylindrical rotary shaft 14 of the motor rotary section 12 has a hollow structure, and the coolant circulation pipe 20 is connected to both ends of a both end hollow section of the cylindrical rotary shaft 14.

Specifically, the hollow section of the cylindrical rotary shaft 14 and the coolant circulation pipe 20 connected to the hollow section forms a coolant circulation path having a closed loop shape.

A bearing 13 is disposed around the hollow section of the cylindrical rotary shaft 14. With this configuration, the motor rotary section 12 can be rotated with a center position of the cylindrical rotary shaft 14 as a center of rotation.

Note that a main heat generating part of the motor 10 is the coil 15 supplied with electric power.

In the above configuration, the hollow section of the cylindrical rotary shaft 14 and the coolant circulation pipe 20 connected to the hollow section form the closed loop coolant circulation path. However, a configuration may be adopted in which the coolant circulation pipe 20 having a closed loop shape penetrates the cylindrical rotary shaft 14 of the motor rotary section 12, to form the closed loop coolant circulation path composed only of the coolant circulation pipe 20.

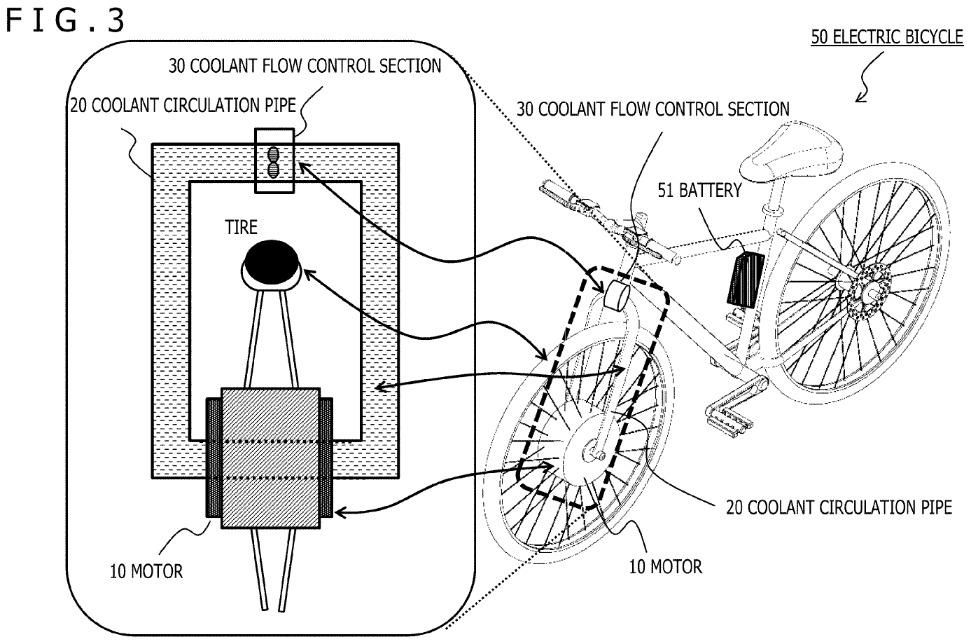

A specific use example of the motor device of the present disclosure will be described below, referring to FIG. 3.

FIG. 3 is a diagram depicting an example of a motor-driven type moving body in which the motor device of the present disclosure is mounted to an electric bicycle 50.

The motor 10 is mounted to the center of a front wheel of the electric bicycle 50, and the front wheel is rotated by the rotation of the motor 10.

A hollow section is set in a central portion of the motor 10, and, further, the coolant circulation pipe 20 extending in a handle direction is connected to the hollow section. By this connecting configuration, a coolant circulation path having a closed loop shape is configured.

The coolant flow control section 30 is mounted to the center of an upper portion of the coolant circulation pipe 20.

Note that the motor 10 and the coolant flow control section 30 is supplied with electric power from a battery 51.

When the motor 10 is rotated, the coolant in the inside of the coolant circulation pipe 20 is circulated in the pipe and in the hollow section of the cylindrical rotary shaft 14 of the motor 10, under control by the coolant flow control section 30.

The coolant stores heat in the inside of the motor 10 when passing through the inside of the motor 10, and releases the heat when passing through a peripheral portion of the motor 10.

With the coolant circulated in the coolant circulation pipe 20, the heat storage and heat release are carried out continuously, whereby the inside of the motor 10 can be prevented from being brought to a high temperature.

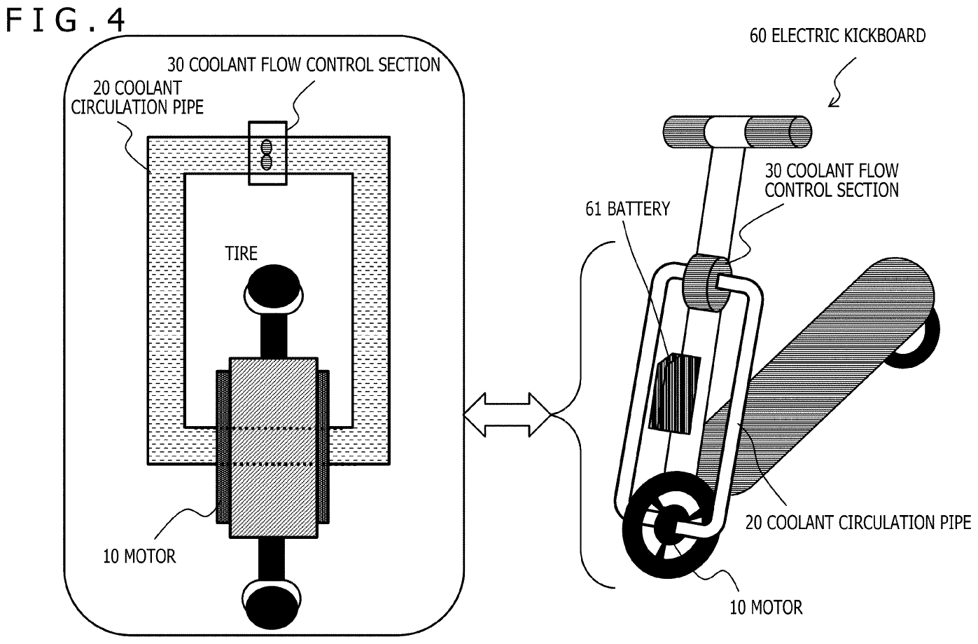

FIG. 4 is another use example of the motor device, and is an example of a motor-driven type moving body in which the motor device of the present disclosure is mounted to an electric Kickboard 60.

The motor 10 is mounted to the center of a front wheel of the electric Kickboard 60, and the front wheel is rotated by the rotation of the motor 10.

A hollow section is set in a central portion of the motor 10, and, further, the coolant circulation pipe 20 extending in a handle direction is connected to the hollow section. By this connecting configuration, a coolant circulation path having a closed loop shape is configured.

The coolant flow control section 30 is mounted to the center of an upper portion of the coolant circulation pipe 20.

Note that the motor 10 and the coolant flow control section 30 are supplied with electric power from a battery 61.

When the motor 10 is rotated, the coolant in the inside of the coolant circulation pipe 20 is circulated in the pipe and in a hollow section of the cylindrical rotary shaft 14 of the motor 10, under control by the coolant flow control section 30.

The coolant stores heat in the inside of the motor 10 when passing through the inside of the motor 10, and releases the heat when passing through a peripheral portion of the motor 10.

With the coolant circulated in the coolant circulation pipe 20, the heat storage and heat release are carried out continuously, whereby the inside of the motor 10 can be prevented from being brought to a high temperature.

Examples in which the motor 10 is mounted to a tire of a moving body such as a bicycle and a Kickboard have been described referring to FIGS. 3 and 4. As aforementioned, however, the motor device of the present disclosure is not limited in application to these moving bodies, but is applicable to other moving bodies, for example, various motors such as motors for rotating media such as CD, BD, and hard disk.

### [2. A Plurality of Embodiments of Control of Flow of Coolant in Coolant Circulation Pipe of Motor Device of the Present Disclosure]

A plurality of embodiments of control of flow of the coolant in the coolant circulation pipe of the motor device of the present disclosure will be described.

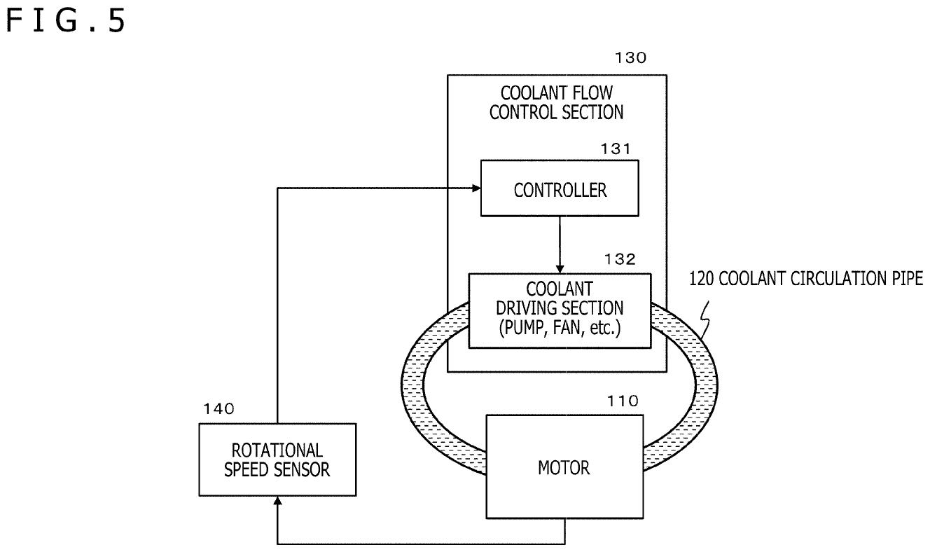

FIG. 5 is a diagram depicting an embodiment of a flow control configuration for a coolant in the motor device of the present disclosure.

A motor 110 has a hollow section around a center axis thereof, and a coolant circulation pipe 120 is connected to the hollow section. By this connecting configuration, a coolant circulation path having a closed loop shape is configured.

Specifically, the coolant circulation path has a closed loop shape configured by the hollow section at the rotary center shaft of the motor 110, and the coolant circulation pipe 120 having a shape surrounding a peripheral portion of the motor 110.

In addition, a coolant flow control section 130 that controls flow of the coolant in the inside of the coolant circulation pipe 120 is mounted to the coolant circulation pipe 120.

As illustrated in FIG. 5, the coolant flow control section 130 includes a controller 131 and a coolant driving section 132.

The controller 131 controls the coolant driving section 132, to change the flow velocity of the coolant flowing in the coolant circulation pipe 120.

The coolant driving section 132 has, for example, a fan or pump configuration, and is configured to be able to change the moving velocity or moving direction of the coolant sealed in the inside of the coolant circulation pipe 120.

As depicted in FIG. 5, the motor device of the present disclosure further includes a rotational speed sensor 140 that detects the rotational speed of the motor 110.

The rotational speed sensor 140 detects the rotational speed of the motor 110, and inputs the detection information to the controller 131 of the coolant flow control section 130.

According to the rotational speed of the motor 110 inputted from the rotational speed sensor 140, the controller 131 controls an output to the coolant driving section 132, to change the flow velocity of the coolant flowing in the coolant circulation pipe 120.

Specifically, a control is performed such that when the rotational speed of the motor 110 is enhanced, the flow velocity of the coolant flowing in the coolant circulation pipe 120 is raised, and, in the case where the rotational speed of the motor 110 is low, the flow velocity of the coolant flowing in the coolant circulation pipe 120 is lowered.

When the rotational speed of the motor 110 is enhanced, the amount of heat generated in the motor 110 is increased; for lowering the heat generation, a control is performed to increase the amount of the coolant passed through the inside of the motor 110 per unit time, thereby enhancing the cooling effect.

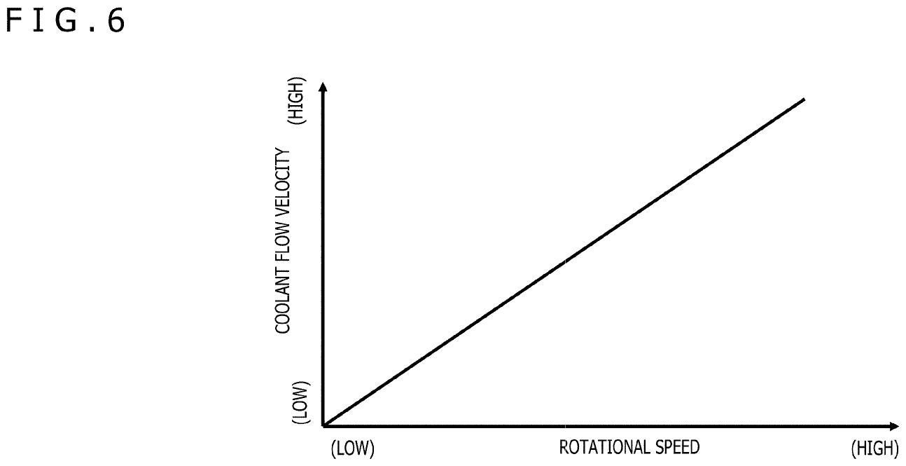

A specific example of flow velocity control for the coolant by the controller 131 of the coolant flow control section 130 is depicted in FIG. 6.

A graph depicted in FIG. 6 is a graph with the axis of abscissas representing the rotational speed of the motor, and with the axis of ordinates representing the flow velocity of the coolant flowing in the coolant circulation pipe 120.

As illustrated in FIG. 6, when the rotational speed of the motor 110 is raised, the flow velocity of the coolant flowing in the coolant circulation pipe 120 is enhanced.

On the other hand, when the rotational speed of the motor 110 is lowered, the flow velocity of the coolant flowing in the coolant circulation pipe 120 is lowered.

In such a way, the controller 131 of the coolant flow control section 130 performs a coolant flow velocity control according to the rotational speed of the motor 110. By this control, a cooling effect according to a heat generation level of the motor 110 can be realized.

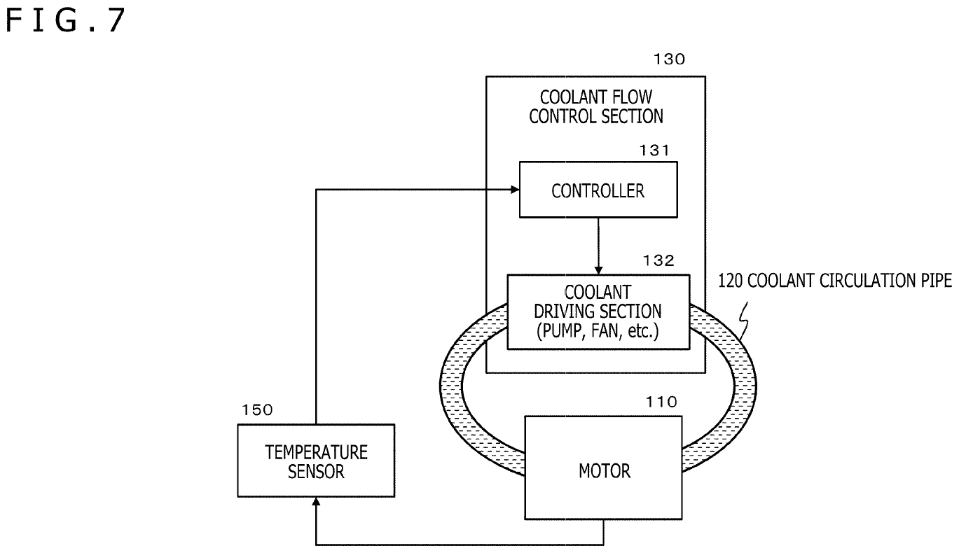

An embodiment of the motor device utilizing a temperature sensor that detects the temperature of the motor 110 will be described, referring to FIG. 7.

A motor device depicted in FIG. 7 is similar to that depicted in FIG. 5 in basis configuration, in which a motor 110 has a hollow section around a center axis thereof, and a coolant circulation pipe 120 is connected to the hollow section. By this connecting configuration, a coolant circulation path having a closed loop shape is configured.

Specifically, the coolant circulation path has a closed loop shape configured by the hollow section at a rotary center shaft of the motor 110, and the coolant circulation pipe 120 having a shape surrounding a peripheral portion of the motor 110.

In addition, a coolant flow control section 130 that controls the flow of the coolant in the inside of the coolant circulation pipe 120 is mounted to the coolant circulation pipe 120.

As depicted in FIG. 7, the coolant flow control section 130 includes a controller 131 and a coolant driving section 132.

The controller 131 controls the coolant driving section 132, to change the flow velocity of the coolant flowing in the coolant circulation pipe 120.

The embodiment illustrated in FIG. 7 includes a temperature sensor 150 that detects the temperature of the motor 110.

The temperature sensor 150 detects the temperature of the motor 110, and inputs the detection information to the controller 131 of the coolant flow control section 130.

According to the temperature of the motor 110 inputted from the temperature sensor 150, the controller 131 controls an output to the coolant driving section 132, to thereby change the flow velocity of the coolant flowing in the coolant circulation pipe 120.

Specifically, a control is performed such that in the case where the temperature of the motor 110 is raised, the flow velocity of the coolant flowing in the coolant circulation pipe 120 is enhanced, and, where the temperature of the motor 110 is low, the flow velocity of the coolant flowing in the coolant circulation pipe 120 is lowered.

In the case where the temperature of the motor 110 is high, it indicates that the amount of heat generated by the motor 110 is increased; for lowering the heat generation, a control is performed such as to increase the amount of the coolant passed through the inside of the motor 110 per unit time, thereby enhancing the cooling effect.

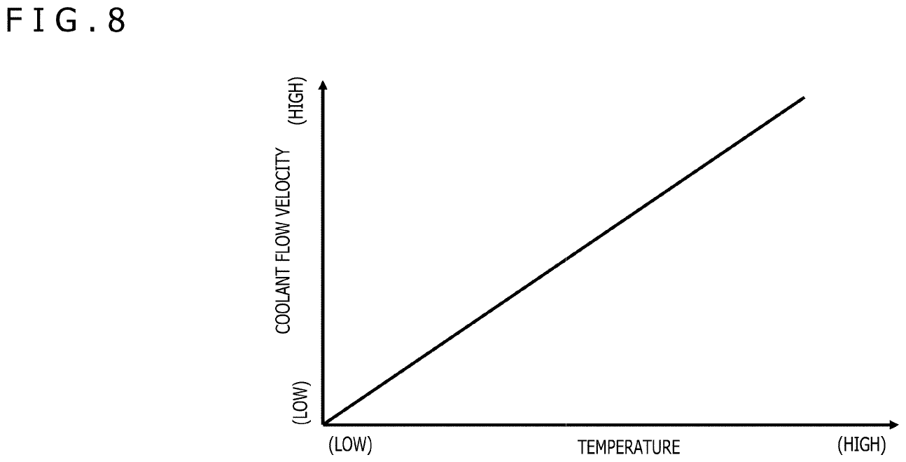

A specific example of flow velocity control for the coolant by the controller 131 of the coolant flow control section 130 is illustrated in FIG. 8.

A graph in FIG. 8 is a graph with the axis of abscissas representing the temperature of the motor, and with the axis of ordinates representing the flow velocity of the coolant flowing in the coolant circulation pipe 120.

As depicted in FIG. 8, when the temperature of the motor 110 is raised, the flow velocity of the coolant flowing in the coolant circulation pipe 120 is enhanced.

On the other hand, when the temperature of the motor 110 is lowered, the flow velocity of the coolant flowing in the coolant circulation pipe 120 is lowered.

In such a way, the controller 131 of the coolant flow control section 130 performs a flow velocity control for the coolant according to the temperature of the motor 110. By this control, a cooling effect according to the heat generation level of the motor 110 can be realized.

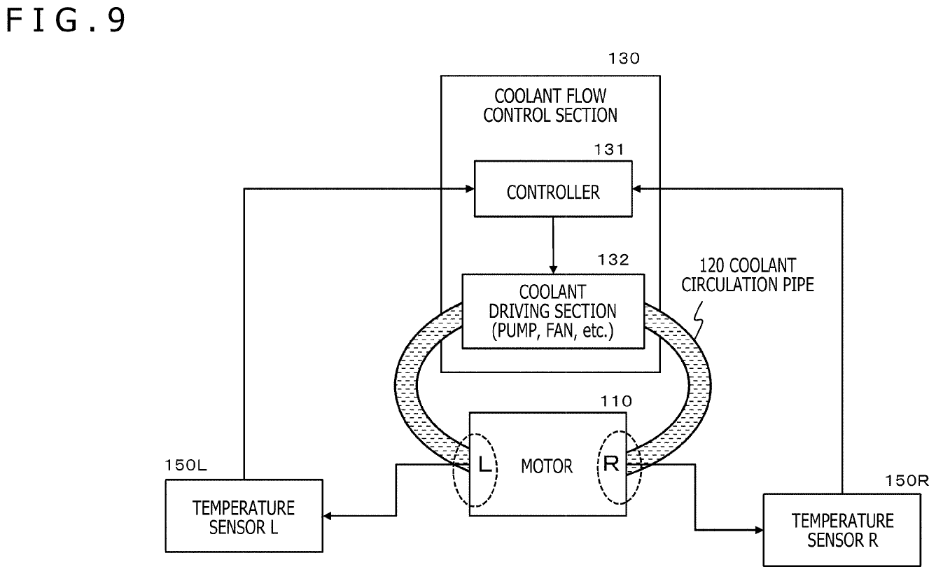

Further, an embodiment of the motor device that performs a control to change the flow direction of the coolant by utilizing a plurality of temperature sensors detecting the temperatures at a plurality of different positions of the motor 110 will be described, referring to FIG. 9 and so on.

The motor device depicted in FIG. 9 is also similar to those illustrated in FIGS. 5 and 7 in basic configuration, in which a motor 110 has a hollow section around a center axis thereof, and a coolant circulation pipe 120 is connected to the hollow section. By this connecting configuration, a coolant circulation path having a closed loop shape is configured.

Specifically, the coolant circulation path has a closed loop shape composed of the hollow section at a rotary center shaft of the motor 110, and the coolant circulation pipe 120 having a shape surrounding a peripheral portion of the motor 110.

In addition, a coolant flow control section 130 that controls the flow of the coolant in the inside of the coolant circulation pipe 120 is mounted to the coolant circulation pipe 120.

As illustrated in FIG. 9, the coolant flow control section 130 includes a controller 131 and a coolant driving section 132.

The controller 131 controls the coolant driving section 132, to change the flow direction of the coolant flowing in the coolant circulation pipe 120.

In the embodiment depicted in FIG. 9, a temperature sensor L or 150L that detects the temperature on the left (L) side of the motor 110 and a temperature sensor R or 150R that detects the temperature on the right (R) side of the motor 110 are provided.

These two temperature sensors L or 150L and R or 150R individually detect the temperatures on the left (L) side and the right (R) side of the motor 110.

Temperature information on the two parts is inputted to the controller 131 of the coolant flow control section 130.

According to the temperatures on the left (L) side and the right (R) side of the motor 110 which are inputted from the two temperature sensors L or 150L and R or 150R, the controller 131 controls an output to the coolant driving section 132, to change the direction of the coolant flowing in the coolant circulation pipe 120.

Specifically, when the temperature on the left (L) side of the motor 110 becomes higher than that on the right (R) side, the direction of the coolant flowing in the coolant circulation pipe 120 is set to be from the left (L) side toward the right (R) side of the motor 110.

On the other hand, when the temperature on the right (R) side of the motor 110 becomes higher than that on the left (L) side, the direction of the coolant flowing in the coolant circulation pipe 120 is set to be from the right (R) side toward the left (L) side of the motor 110.

With such a setting, the coolant at a low temperature is supplied to a region in which the temperature is higher, whereby a cooling efficiency can be enhanced.

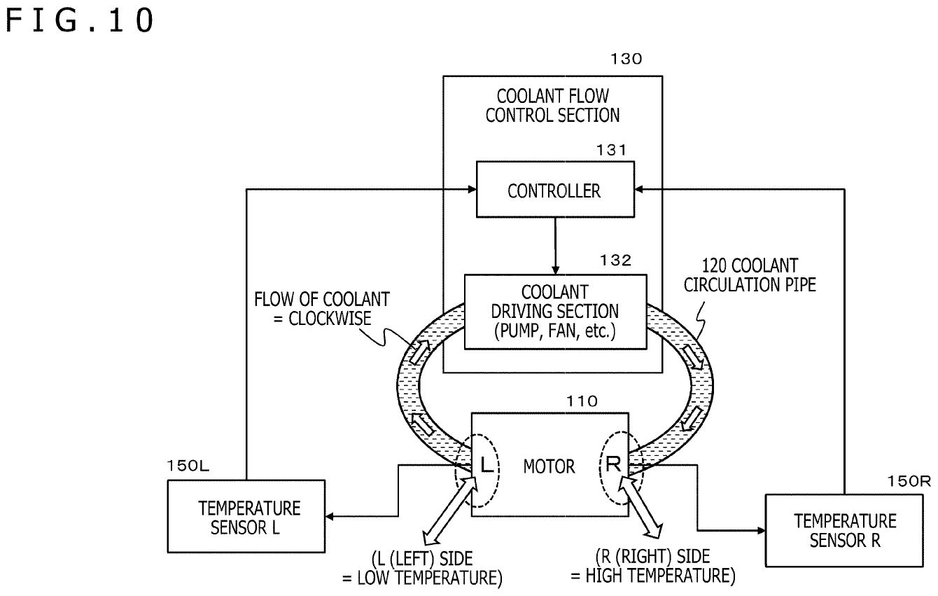

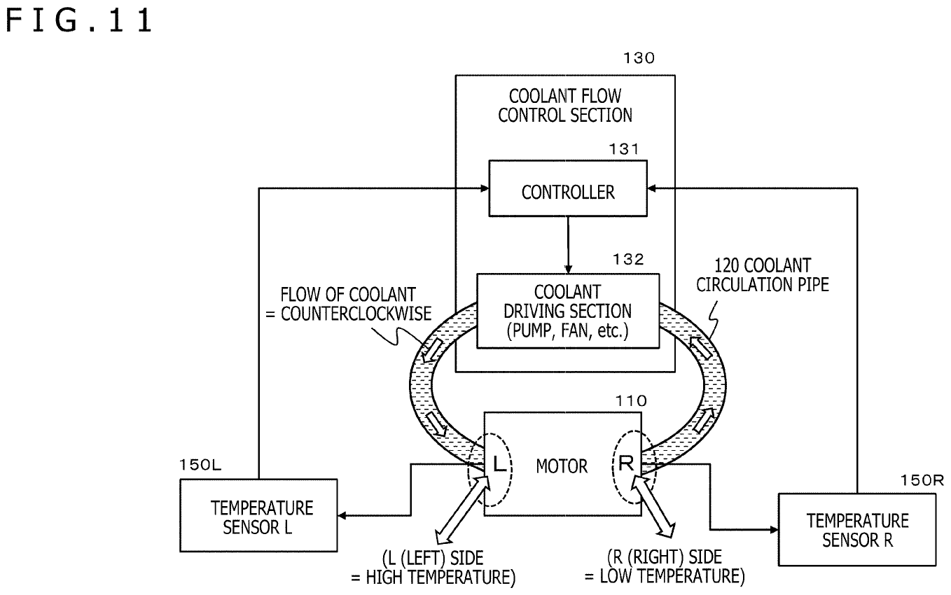

A control example of a specific flow direction of the coolant is illustrated in FIGS. 10 and 11.

FIG. 10 is a control example of the flow direction of the coolant in the case where the temperature on the right (R) side of the motor 110 is higher than that on the left (L) side.

In this case, the controller 131 of the coolant flow control section 130 performs a control to set the direction of the coolant flowing in the coolant circulation pipe 120 to be clockwise, namely, from the right (R) side toward the left (L) side of the motor 110.

FIG. 11 is a setting reverse to that in FIG. 10, and is a control example of the flow direction of the coolant in the case where the temperature on the left (L) side of the motor 110 is higher than that on the right (R) side.

In this case, the controller 131 of the coolant flow control section 130 performs a control to set the direction of the coolant flowing in the coolant circulation pipe 120 to be counterclockwise, namely, from the left (L) side toward the right (R) side of the motor 110.

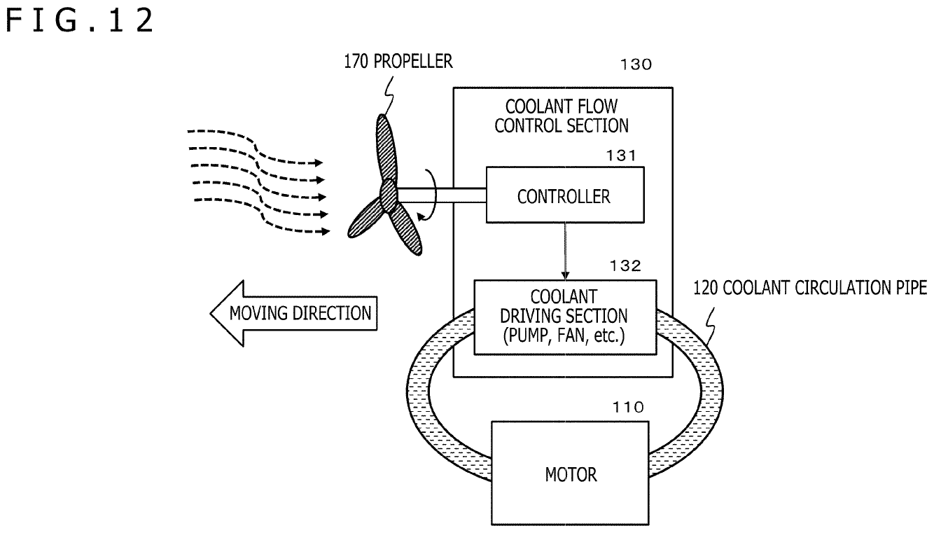

Further, an example of control of flow velocity of the coolant according to the velocity of a moving body such as, for example, a bicycle equipped with the motor, without setting sensors in the motor 110, will be described referring to FIG. 12.

A motor device illustrated in FIG. 12 is similar to those depicted in FIGS. 5 and 7 and the like in basic configuration, and the motor 110 has a hollow section around a center axis thereof, with a coolant circulation pipe 120 connected to the hollow section. By this connecting configuration, a coolant circulation path having a closed loop shape is configured.

Specifically, the coolant circulation path has a closed loop shape composed of the hollow section at a rotary center shaft of the motor 110, and the coolant circulation pipe 120 having a shape surrounding a peripheral portion of the motor 110.

In addition, a coolant flow control section 130 that controls the flow of the coolant in the inside of the coolant circulation pipe 120 is mounted to the coolant circulation pipe 120.

As depicted in FIG. 12, the coolant flow control section 130 includes a controller 131 and a coolant driving section 132.

The controller 131 controls the coolant driving section 132, to change the flow velocity of the coolant flowing in the coolant circulation pipe 120.

In the embodiment illustrated in FIG. 12, a propeller 170 is mounted to the controller 131, and an output to the coolant driving section 132 is controlled according to the rotational speed of the propeller 170, thereby changing the flow velocity of the coolant flowing in the coolant circulation pipe 120.

Specifically, a control is performed such that when the rotational speed of the propeller 170 is enhanced, the flow velocity of the coolant flowing in the coolant circulation pipe 120 is enhanced, and, when the rotational speed of the propeller 170 is lowered, the flow velocity of the coolant flowing in the coolant circulation pipe 120 is lowered.

The propeller 170 is mounted to a front surface of the moving body such as a bicycle, and is rotated at a higher speed as the traveling velocity of the moving body such as a bicycle increases.

The traveling velocity of the moving body such as a bicycle and the rotational speed of the motor 110 are in a proportional relation, and the rotational speed of the propeller 170 is proportional to the rotational speed of the motor 110.

In other words, when the rotational speed of the motor 110 is raised and the amount of heat generated by the motor 110 is increased, the traveling velocity of the moving body such as a bicycle is enhanced, resulting in that the rotational speed of the propeller 170 is enhanced.

As a result, the flow velocity of the coolant flowing in the coolant circulation pipe 120 is enhanced, whereby a cooling effect can be enhanced.

The embodiment illustrated in FIG. 12 is a configuration in which a cooling effect according to the amount of heat generated by the motor 110 is generated, without setting a special sensor in the motor 110.

Note that while a plurality of embodiments of the motor device have been described referring to FIGS. 5 to 12, these embodiments are not limited to individual embodiment configurations, and configurations of a plurality of embodiments can be combined with one another.

### 3. Other Embodiments

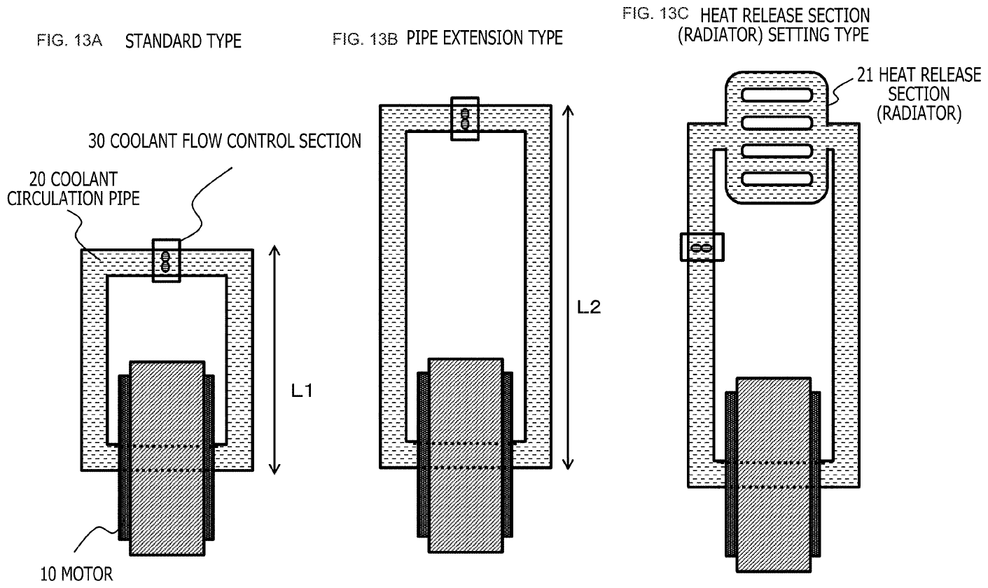

Further, other embodiments of the motor device of the present disclosure will be described referring to FIG. 13.

FIG. 13 depicts the following three different types of the motor device of the present disclosure.

(a) Standard type

(b) Pipe extension type

(c) Heat release section (radiator) type

A motor device of (a) standard type is the motor device as described referring to FIG. 1 and so on, in which the motor 10 is provided with the coolant circulation pipe 20 penetrating the inside of the motor 10, and the coolant flow control section 30 that controls the flow of the coolant in the inside of the coolant circulation pipe 20 is mounted to the coolant circulation pipe 20.

A motor device of (b) pipe extension type has a configuration including the motor 10, the coolant circulation pipe 20, and the coolant flow control section 30, like that of (a) standard type, in which the length of the coolant circulation pipe 20 is set to be longer than that in (a) standard type.

With the length of the coolant circulation pipe 20 thus enlarged, the time for which the coolant in the inside of the coolant circulation pipe 20 makes contact with the outside air through the pipe is prolonged, the heat stored in the coolant becomes liable to be released, and a cooling effect can be enhanced.

A motor device of (c) heat release section (radiator) setting type also has a configuration including the motor 10, the coolant circulation pipe 20, and the coolant flow control section 30, like that of (a) standard type, in which a heat release section (radiator) 21 is set in part of the coolant circulation pipe 20.

The coolant circulation pipe 20 has, at part thereof, the heat release section (radiator) 21 in which the flow path of the coolant is branched into a plurality of flow paths.

With the heat release section (radiator) 21 thus set in part of the coolant circulation pipe 20, the heat stored in the coolant becomes liable to be released through the heat release section (radiator) 21, whereby a cooling effect can be enhanced.

### 4. Summary of Configuration of the Present Disclosure

Embodiments of the present disclosure have been described in detail while referring to the specific embodiments above. However, it is clear that those skilled in the art can make corrections and substitutions within the scope of the gist of the present disclosure. In other words, the present invention has been disclosed in the form of illustrations, which are not to be construed as limitative. To judge the gist of the present disclosure, the column of claims should be taken into account.

Note that the technology disclosed herein can take the following configurations.

(1)

A motor device including:

a rotary shaft of a hollow structure;

a motor section rotated around the rotary shaft;

a coolant circulation pipe that is connected to both ends of the rotary shaft and that constitutes a closed loop shaped coolant circulation path together with a hollow section of the rotary shaft; and

a coolant flow control section that controls flow of a coolant in the coolant circulation pipe.

(2)

The motor device as described in the above paragraph (1), further including:

a rotational speed sensor that detects rotational speed of the motor section,

in which the coolant flow control section
receives detection information from the rotational speed sensor as an input, and performs a control to accelerate a flow of the coolant in the coolant circulation pipe according to a rise in the rotational speed of the motor section.
   (3)

The motor device as described in the above paragraph (1) or (2), further including:

a temperature sensor that detects temperature of the motor section,

in which the coolant flow control section
receives detection information from the temperature sensor as an input, and performs a control to accelerate a flow of the coolant in the coolant circulation pipe according to a rise in the temperature of the motor section.
   (4)

The motor device as described in any one of the above paragraphs (1) to (3), further including:

a plurality of temperature sensors that detects temperatures at different positions of the motor section,

in which the coolant flow control section
receives detection information from the plurality of temperature sensors as inputs, and controls flow direction of the coolant in the coolant circulation pipe in such a manner that the coolant flows from a high temperature position side toward a low temperature position side in the motor section.
   (5)

The motor device as described in any one of the above paragraphs (1) to (4), further including:

a propeller that rotates according to movement of a moving body equipped with the motor section,

in which the coolant flow control section
receives rotational speed information from the propeller as an input, and performs a control to accelerate a flow of the coolant in the coolant circulation pipe according to a rise in rotational speed of the propeller.
   (6)

The motor device as described in any one of the above paragraphs (1) to (5),

in which the coolant circulation pipe has a heat release section in which a flow path of the coolant is branched into a plurality of flow paths.

(7)

The motor device as described in any one of the above paragraphs (1) to (6),

in which the motor section includes an in-wheel motor that drives a wheel of a moving body.

(8)

A motor-driven type moving body including:

a rotary shaft of a hollow structure;

a motor section that rotates around the rotary shaft;

a motor-driven type tire that is equipped with the motor section at a central portion thereof;

a coolant circulation pipe that is connected to both ends of the rotary shaft and that constitutes a closed loop shaped coolant circulation path together with a hollow section of the rotary shaft; and

a coolant flow control section that controls a flow of the coolant in the coolant circulation pipe.

(9)

The motor-driven type moving body as described in the above paragraph (8), further including:

a rotational speed sensor that detects rotational speed of the motor section,

in which the coolant flow control section
receives detection information from the rotational speed sensor as an input, and performs a control to accelerate a flow of the coolant in the coolant circulation pipe according to a rise in the rotational speed of the motor section.
   (10)

The motor-driven type moving body as described in the above paragraph (8) or (9), further including:

a temperature sensor that detects temperature of the motor section,

in which the coolant flow control section
receives detection information from the temperature sensor as an input, and performs a control to accelerate a flow of the coolant in the coolant circulation pipe according to a rise in the temperature of the motor section.
   (11)

The motor-driven type moving body as described in any one of the above paragraphs (8) to (10), further including:

a plurality of temperature sensors that detect temperatures at different positions of the motor section,

in which the coolant flow control section
receives detection information from the plurality of temperature sensors as inputs, and controls flow direction of the coolant in the coolant circulation pipe in such a manner that the coolant flows from a high temperature position side toward a low temperature position side in the motor section.
   (12)

The motor-driven type moving body as described in any one of the above paragraphs (8) to (11), further including:

a propeller that rotates according to movement of a moving body equipped with the motor section,

in which the coolant flow control section
receives rotational speed information from the propeller as an input, and performs a control to accelerate a flow of the coolant in the coolant circulation pipe according to a rise in rotational speed of the propeller.
   (13)

The motor-driven type moving body as described in any one of the above paragraphs (8) to (12),

in which the coolant circulation pipe has a heat release section in which a flow path of the coolant is branched into a plurality of flow paths.

(14)

The motor-driven type moving body as described in any one of the above paragraphs (8) to (13),

in which the motor section includes an in-wheel motor that drives a wheel of a moving body.

Note that various kinds of processes described herein are not only be carried out in time series according to the description but may also be carried out concurrently or individually according to the processing capability of the device that performs the processes or as required. In addition, the system herein is a logical set configuration of a plurality of devices, and is not limited to those in which the devices of configurations are present in the same housing.

### INDUSTRIAL APPLICABILITY

As aforementioned, according to the configuration of one embodiment of the present disclosure, a motor device and a motor-driven type moving body that realize efficient cooling of a motor are realized.

Specifically, the motor device includes, for example, a rotary shaft of a hollow structure, a motor section that rotates around the rotary shaft, a coolant circulation pipe that is connected to both ends of the rotary shaft and that constitutes a closed loop shaped coolant circulation path together with a hollow section of the rotary shaft, and a coolant flow control section that controls a flow of the coolant in the coolant circulation pipe. The motor device includes a rotational speed sensor that detects the rotational speed of the motor, and a temperature sensor that detects the temperature of the motor. The coolant flow control section receives detection information from the rotational speed sensor and the temperature sensor as an input, and performs a control to accelerate the flow of the coolant in the coolant circulation pipe according to a rise in the rotational speed of the motor and a rise in temperature.

According to the present configuration, a motor device and a motor-driven type moving body that realize efficient cooling of a motor are realized.

### REFERENCE SIGNS LIST

10 Motor
11 Motor base
12 Motor rotary section
13 Bearing
14 Cylindrical rotary shaft
15 Coil
20 Coolant circulation pipe
21 Heat release section (radiator)
30 Coolant flow control section
50 Electric bicycle
51 Battery
60 Electric Kickboard
61 Battery
110 Motor
120 Coolant circulation pipe
130 Coolant flow control section
131 Controller
132 Coolant driving section
140 Rotational speed sensor
150 Temperature sensor
170 Propeller

1. A motor device comprising:
a rotary shaft of a hollow structure;
a motor section rotated around the rotary shaft;
a coolant circulation pipe that is connected to both ends of the rotary shaft and that constitutes a closed loop shaped coolant circulation path together with a hollow section of the rotary shaft; and
a coolant flow control section that controls flow of a coolant in the coolant circulation pipe.

2. The motor device according to claim 1, further comprising:
a rotational speed sensor that detects rotational speed of the motor section,
wherein the coolant flow control section
receives detection information from the rotational speed sensor as an input, and performs a control to accelerate a flow of the coolant in the coolant circulation pipe according to a rise in the rotational speed of the motor section.

3. The motor device according to claim 1, further comprising:
a temperature sensor that detects temperature of the motor section,
wherein the coolant flow control section
receives detection information from the temperature sensor as an input, and performs a control to accelerate a flow of the coolant in the coolant circulation pipe according to a rise in the temperature of the motor section.

4. The motor device according to claim 1, further comprising:
a plurality of temperature sensors that detects temperatures at different positions of the motor section,
wherein the coolant flow control section
receives detection information from the plurality of temperature sensors as inputs, and controls a flow direction of the coolant in the coolant circulation pipe in such a manner that the coolant flows from a high temperature position side toward a low temperature position side in the motor section.

5. The motor device according to claim 1, further comprising:
a propeller that rotates according to movement of a moving body equipped with the motor section,
wherein the coolant flow control section
receives rotational speed information from the propeller as an input, and performs a control to accelerate a flow of the coolant in the coolant circulation pipe according to a rise in rotational speed of the propeller.

6. The motor device according to claim 1,
wherein the coolant circulation pipe has a heat release section in which a flow path of the coolant is branched into a plurality of flow paths.

7. The motor device according to claim 1,
wherein the motor section includes an in-wheel motor that drives a wheel of a moving body.

8. A motor-driven type moving body comprising:
a rotary shaft of a hollow structure;
a motor section that rotates around the rotary shaft;
a motor-driven type tire that is equipped with the motor section at a central portion thereof;
a coolant circulation pipe that is connected to both ends of the rotary shaft and that constitutes a closed loop shaped coolant circulation path together with a hollow section of the rotary shaft; and
a coolant flow control section that controls a flow of the coolant in the coolant circulation pipe.

9. The motor-driven type moving body according to claim 8, further comprising:
a rotational speed sensor that detects rotational speed of the motor section,
wherein the coolant flow control section
receives detection information from the rotational speed sensor as an input, and performs a control to accelerate a flow of the coolant in the coolant circulation pipe according to a rise in the rotational speed of the motor section.

10. The motor-driven type moving body according to claim 8, further comprising:
a temperature sensor that detects temperature of the motor section,
wherein the coolant flow control section
receives detection information from the temperature sensor as an input, and performs a control to accelerate a flow of the coolant in the coolant circulation pipe according to a rise in the temperature of the motor section.

11. The motor-driven type moving body according to claim 8, further comprising:
a plurality of temperature sensors that detects temperatures at different positions of the motor section,
wherein the coolant flow control section
receives detection information from the plurality of temperature sensors as inputs, and controls flow direction of the coolant in the coolant circulation pipe in such a manner that the coolant flows from a high temperature position side toward a low temperature position side in the motor section.

12. The motor-driven type moving body according to claim 8, further comprising:
a propeller that rotates according to movement of a moving body equipped with the motor section,
wherein the coolant flow control section
receives rotational speed information from the propeller as an input, and performs a control to accelerate a flow of the coolant in the coolant circulation pipe according to a rise in rotational speed of the propeller.

13. The motor-driven type moving body according to claim 8,
wherein the coolant circulation pipe has a heat release section in which a flow path of the coolant is branched into a plurality of flow paths.

14. The motor-driven type moving body according to claim 8,
wherein the motor section includes an in-wheel motor that drives a wheel of a moving body.
